(19) United States
(12) Patent Application Publication
(10) Pub. No.: US 2006/0094285 A1
(43) Pub. Date: May 4, 2006

(54) Rotating electrical connector

(75) Inventor: Steven Newell, Petaluma, CA (US)

Correspondence Address: EDWARD S. SHERMAN, ESQ., 3554 ROUND BARN BLVD., SUITE 303, SANTA ROSA, CA, 95403, US

(73) Assignee: PANAMAX

(21) Appl. No.: 10/981,913

(22) Filed: Nov. 4, 2004

(51) Int. Cl. H01R 13/56

(52) U.S. Cl. 439/446

(57) ABSTRACT

An adjustable electrical connector has front and a back tubular components that mate via a rotatable connection at faces disposed obliquely from the plug/socket and cord connecting portion of the connector such that cord can be disposed at angle of 0 to 90 degrees with respect to the outlet.

### CROSS REFERENCE TO RELATED APPLICATIONS

None

### BACKGROUND OF INVENTION

The present invention relates to electrical connectors. More specifically, the present invention relates to an electrical connector assembly having a rotatable portion.

Rotatable electrical connector assemblies are known in the art. Prior rotatable electrical connectors generally have a main body portion that contains the extending metal prongs of an electrical plug, or the recessed electrical terminals of a socket, and a connected rotatable portion from which the electrical cord of cable extends at right angle to prongs or terminals, that is at a right angle from the wall plate or connected electrical device. Electrical connection is maintained between the fixed and rotatable portions to allow electric current to flow from the electrical wall socket to the electric appliance at any given angle of the rotatable portion with respect to the fixed portion.

While this configuration can be versatile in permitting the close or adjacent connection of electrical components to wall or a socket with a power cord between the wall and closely placed furniture, it has the limitation. For example, it might not be discovered that a right angle connector is needed until after several pieces of adjacent equipment are already installed. Furthermore, in some cases, the desired angle of the rotatable portion might be less than 90 degrees. In addition, it may not be possible to estimate this angle under other equipment is installed or located, for example, when the first piece of equipment obscures the open sockets on a wall outlet or fixed power outlet strip.

While it is desirable that such right angle connectors permit the full rotation of the right angle extending portion about 360 degrees, this can subject fixed wiring, between the terminals in the fixed portion and the wiring in the rotating component, to entanglement and failure from the strain in twisting from multiple rotations about 360 degrees. Accordingly, many designs avoid this problem by using of moving electrical contacts or brushes to maintain electrical continuity across the rotary coupling of the connector. However, such brushes or other moving electrical contacts present issues of reliability and may limit the maximum current handling capacity to unacceptable levels.

It is therefore a first object of the present invention to provide a rotating electrical connector that permits closer mounting of electronic components or power cords either adjacent to a wall or between a wall and other equipment.

It is yet another objective to provide an electrical plug and cord where the emergent angle of the cord can be modified after the equipment is connected, and in particular modified between 0 and 90 degrees.

It is a further objective of the invention to provide such benefits without the danger of twisting or damaging the electrical cable and wires, yet avoiding the potentially lower reliability of moving electrical contacts or an inherent limitations to the maximum current carrying of the connector.

Further, as the close installation of multiple electronic components is becoming more common, it is also desirable to provide a convenient and secure method of marking the identity of the connected component on such a rotatable electrical connector.

### SUMMARY OF INVENTION

In the present invention, the first object is achieved by providing an electrical connector formed of a front housing having a forward face for receiving a plug or socket prongs as a face assembly and a rearward face disposed obliquely from the forward face, a back housing having a rearward face for receiving a cord with wire connected to the plug or sockets of the front housing via a hole connecting the rearward and forward face thereof, and a rotating connection between the rearward face of the front housing and the forward face of the back housing.

A second object of the invention is characterized in that the rotary connection between the front housing and the back housing has a mechanical stop that limits rotation to no more than 180 degrees in each direction, thus preventing twisting of wires passing there through.

Another object of the invention is achieved by providing in at least one of the front and rear housing one or more recesses for disposing a printed label or other writing, which is covered by a removable transparent plastic window.

The aforementioned features of the various embodiment of the invention cooperate to permits closer mounting of electronic components to a wall wherein the plug and cord angle are adaptable after components are connected to provide a secure, high integrity power connection with permanent and secure labeling of connected components via the attached electrical connectors.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a schematic illustration showing the rotating electrical connector with respect to a reference coordinate system;

FIG. 2A is an elevation of the rotating electrical connector in a first configuration;

FIG. 2B is an elevation of the rotating electrical connector in a second configuration;

FIG. 3A is a perspective view of a first embodiment of the rotating electrical connector;

FIG. 3B is a plan view from above the rotating electrical connector of FIG. 3A;

FIG. 3C is an elevation of the front of rotating electrical connector of FIG. 3A;

FIG. 3D is an elevation of the right side of rotating electrical connector of FIG. 3A;

FIG. 4 is an exploded view of the components used to assemble the rotating electrical connector depicted in FIG. 3;

FIG. 5A is a perspective view of the partially assembled rotating electrical connector according to the embodiment of FIG. 3;

FIG. 5B is a plan view from above the rotating electrical connector of FIG. 5A;

FIG. 5C is an elevation of the front of the rotating electrical connector of FIG. 5A;

FIG. 5D is a cross-sectional elevation showing the assembly of the front, back and washer components of FIG. 4 with a cable and wires connected to the prongs of the rotating electrical connector;

FIG. 6A is an elevation of the rotating wiper;

FIG. 6B is an elevation of the rotating wiper orthogonal to the elevation in FIG. 6A;

FIG. 7A is an elevation of the face assembly as viewed looking into the rotating electrical connector;

FIG. 7B is a plan view of a section of the face assembly of FIG. 7A at reference line B-B′;

FIGS. 8A and 8B are elevated section views of the rotary coupling of the connector in two alternative positions showing the orientation of the wiper and wedge with respect to the end stops in the front and rear halves; and

FIG. 8C is an elevated sectional view orthogonal to the view in FIG. 8B.

### DETAILED DESCRIPTION

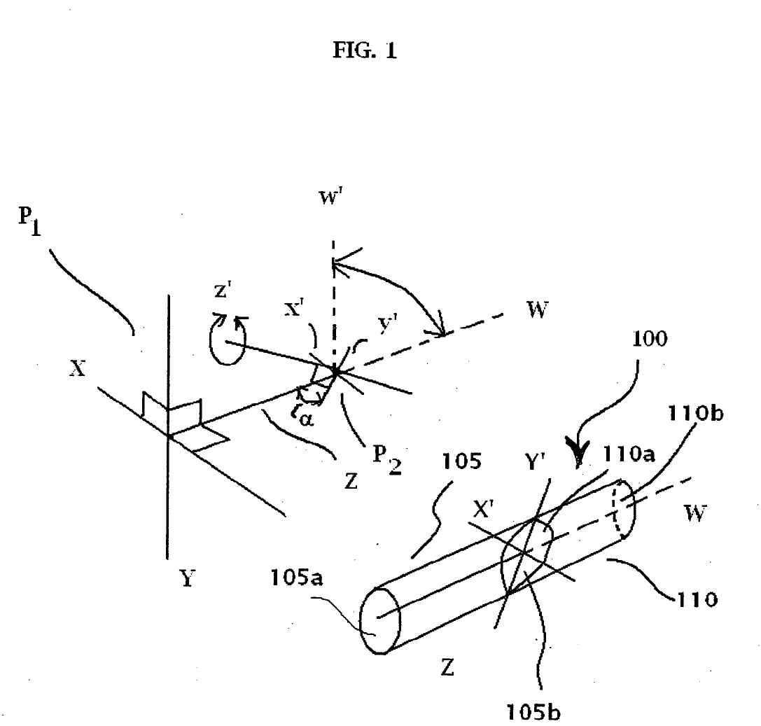

Referring to FIGS. 1 through 8, wherein like reference numerals refer to like components in the various views, there is illustrated therein a new and improved rotating electrical connector, generally denominated 100 herein.

In accordance with the present invention, FIG. 1 illustrates a coordinate system to define the operative principles of the rotating connector 100. Major orthogonal axis X and Y define plane P₁. The rotating connector 100 has a front half 105 with a front face 105a. Either metal prongs extend from face 105a in the −Z-direction for a plug connector or electrical terminals extend inward in the +Z-direction for a socket connector, the prongs or terminal being parallel to the longitudinal axis of connector 100, which is disposed orthogonal to the front face 105a. Thus, when the plug form is inserted into a wall socket (or the socket embodiment is mated with a recess having receiving prongs on an electronic device) the front face 105a is urged to make contact with the wall (or the internal face of the electronic device.) The rear face 105b of front half 105 is defined by common to the X′-axis and the Y′-axis, in which axis Y′ is disposed within Y-Z plane while the X′-axis is parallel to X-axis. The third or Z′-axis is orthogonal to the plane P₂ defined by X′-Y plane, with the Z′-axis is disposed at angle α from plane P₁. The rotating connector 100 has a back half 110 with a front face 110a in communication with rear face 105b of front half 105. In a preferred embodiment, a power cord would emerge from the rear face 10b of rear half 110. Generally, when the rotating connector is in the nominal or non-rotated configuration the power cord will emerge from rear face 110b in the direction of Z-axis, which is along vector W. The front 105 and back 110 half of rotating connector 100 engage in a rotary coupling 115 at plane P₂. Rotation of the back half 110 about axis Z′ allows the power cord to emerge from a continuum of positions intermediate between vector W and W′, which emerge out of the Z-Y plane as the back half 110 rotates about the Z′-axis.

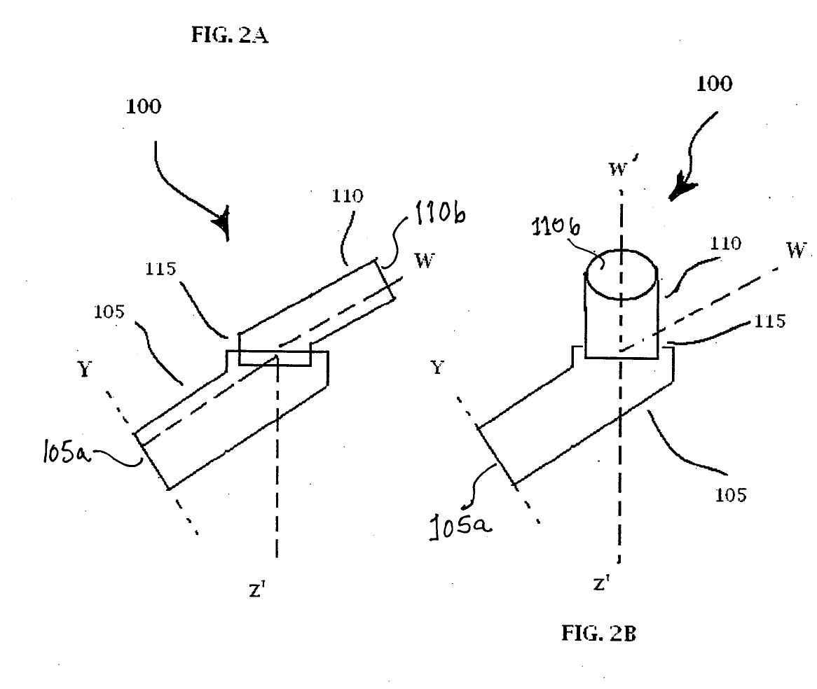

FIG. 2 further illustrates two of the alternatives positions of the back half 110 of rotating connector 100 as elevations in the Y-X plane, showing the rotary coupling 115 with the front half 105. FIG. 2A corresponds to the configuration of FIG. 1 where the back half 110 of connector 100 is disposed with its longitudinal axis parallel to the Z-axis and vector W. In FIG. 2B, the back half 110 of connector 100 is disposed with its longitudinal axis parallel to vector W′.

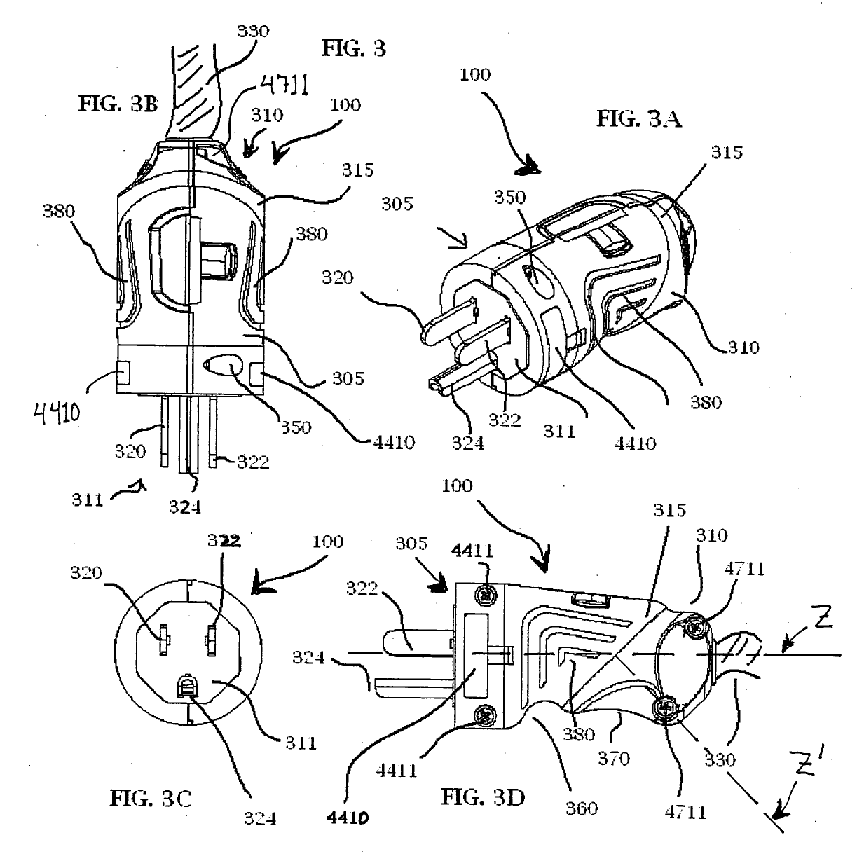

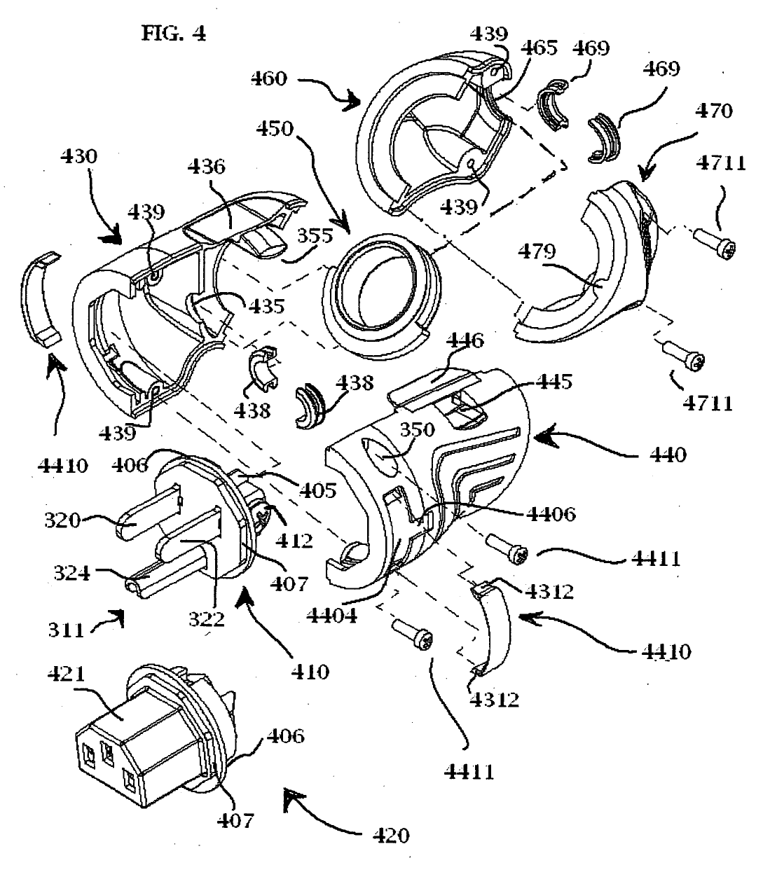

More preferred embodiments of the invention are illustrated in FIGS. 3 through 8 to further define the preferred embodiment of the rotary coupling 115 and the method of assembling the rotating connector 100. In FIG. 3, the rotating electrical connector assembly 100 includes a generally cylindrical fixed housing as the front half 305 having a longitudinal axis Z, and a rotatable housing as the rear half 310, also generally cylindrical, connected to the fixed portion 305, to be rotatable about the longitudinal axis Z′, as illustrated in FIG. 3D. The preferred angular offset, α, between the Z and Z′ axis is about 45 degrees. The front half or fixed housing when fully assembled has a longitudinal body including an electrical connector 311, at a first end thereof with conventional line prong 320, neutral prong 322 and ground prong 324. The front half 305 is connected to the rear half 310 via a rotary coupling 315. A power cord 330 emerges from rear side of rear half 310, that is opposite rotary coupling 315.

FIG. 4 illustrates further details of the construction and assembly of the front half 305 and the rear half 310, as well as rotary coupling 315. Front 305 and back 310 halves are generally tubular and hollow housings for receiving a cable with a least 2 wires. The front half 305 and rear half 310 are each assembled from hemispherical shells that snap and/or are screwed together after the wiring connections are made. Thus, the front half 305 of rotating connector 100 is assembled from half shells 430 and 440, as shown in FIG. 4, whereas the back half 310 is assembled from half shells 460 and 470.

The front half 305 accepts multiple types of faces assemblies, which comprise the external electrical connecting portion of connector 100. The selection of the face assembly 410 or 420 determines whether the rotating connector 100 is a plug or socket connector. Face assembly 410 preferably corresponds to a NEMA 5-15 type plug whereas face assembly 420 corresponds to an IEC 320 type socket for attachment to electronic components.

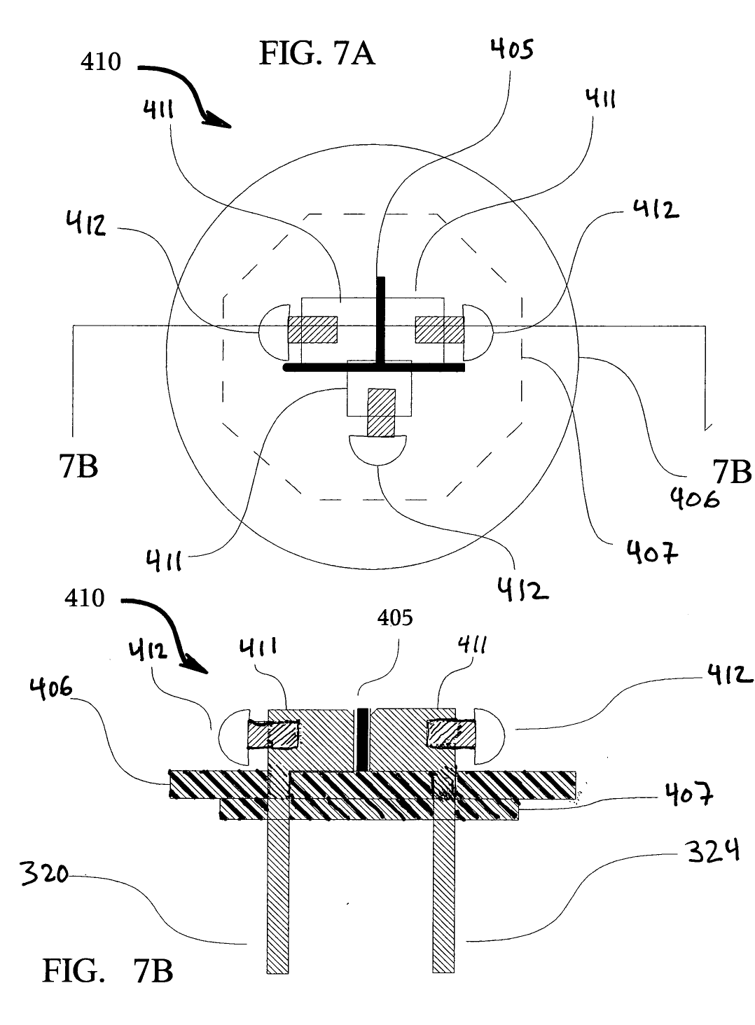

Each of the shells 430 and 440 that forms the front half 305 have at their front opening an edge profile that includes a half of a circular channel adjacent to half of an octagonal recess. The channel and recess complements the mating features at the edge of either face assembly 410 and 420 for insertion of the face assembly into each of half shells 430 and 440. The plug style face assembly 410 is further illustrated in orthogonal sections in FIG. 7. Briefly, in face assembly 410, the prongs 320, 324 and 326 protrude outward orthogonal to octagonal plate 406. A circular plate 407 is attached to opposing side of octagonal plate 406. Referring to FIGS. 7A and 7B, the prongs pass through the octagonal and circular plates to emerge on the other side as electrically isolated terminal blocks 411, each separated from each other by a T-shaped divider 405 attached to circular plate 407. The terminal blocks being conventional, contain a wire well having disposed therein a screw activated clamps. Thus, each conductor block 411 has a threaded bore or clamp mechanism for receiving mating terminal screws 412. The end of the wire 4321 is inserted into the wire well (not shown) such that rotation of terminal screws 412 activates a clamp to grasps the bare conductor wire.

Socket forming face assembly 420 has a 5-sided block 421 that protrudes outward from the octagonal plate 406. The block contains electrically isolated terminals connected to respective terminal blocks 411 on the opposite side of circular plate 407, as in face assembly 410.

The octagonal shape of the plate 406 on the face assembly allows the orientation of back half 310 of connector 100 with respect to the mated prong and socket orientation from among 8 positions. Thus, the octagonal shaped recess 431 (when assembled) in the front edge of the half shells 430 and 440 provides for retaining the face assembly in any of the 8 alternative orientations as the face assembly is rotated about the longitudinal axis of front half 305. The face assembly 410 and forward end of the front half 305 of the connector 100 may have a variety of alternative complimentary and mating shapes with circular symmetry such that the prongs of the terminal can be rotated and securely engaged at discrete angular intervals, that is not limited to the 45 degree increment provided by the octagonal plate 406.

Each of the shell halves also has an edge recess profile that is the compliment of a half symmetric section of wiper 450, more specifically this complementary profile is disposed on the back of the rear half 305 and the front of the back half 315 of the connector 100.

Each of shells 430 and 440 that form front half 305 have an inner or wire strain relief aperture 435 that serves to clamps two or three wires connected to terminal block 411 after the outer cable jacketing has been stripped, thus providing strain relief to the terminal block connections of the bare conductors. Optionally, a pair of hemispherical ring shaped wire capture shims 438 can be inserted between the edge of the aperture 435 and the wire to form a first strain relief insert, as may be required when the combined diameter of the wire bundle would otherwise be to narrow to be securely grasped by the aperture 435.

Each of shells 460 and 470 that form rear half 310 have a cable or exit aperture 465 to grasp exiting cable 330 and provide further strain relief to the mechanical connections in connector 100. Another strain relief insert may be formed from a pair of hemispherical ring shaped shims 469. The shims are inserted into the partial aperture in each half shell such that on assembly they surround the edge of aperture 465, narrowing the effective diameter to grasp smaller diameter cables.

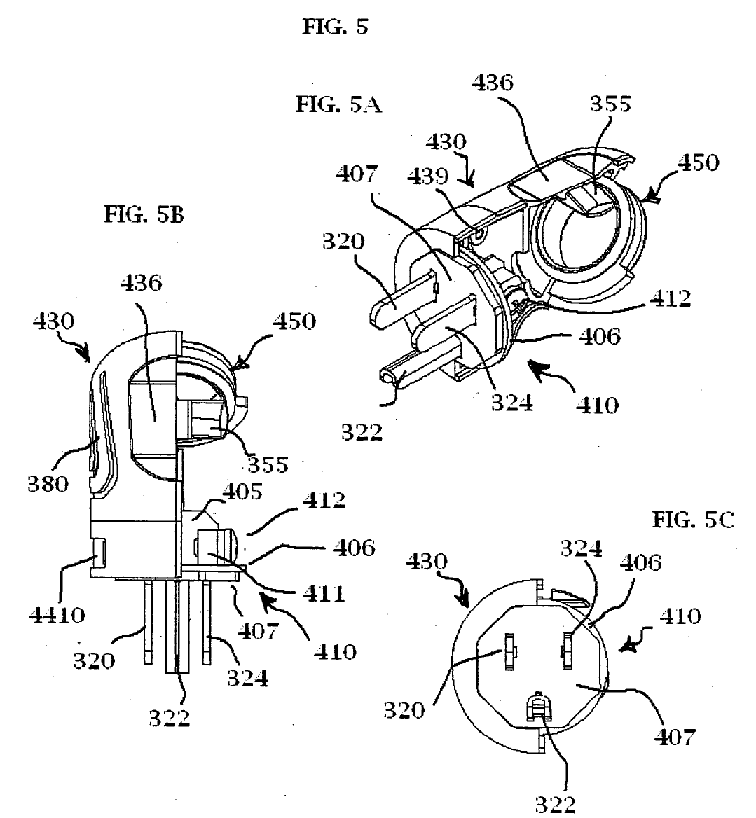

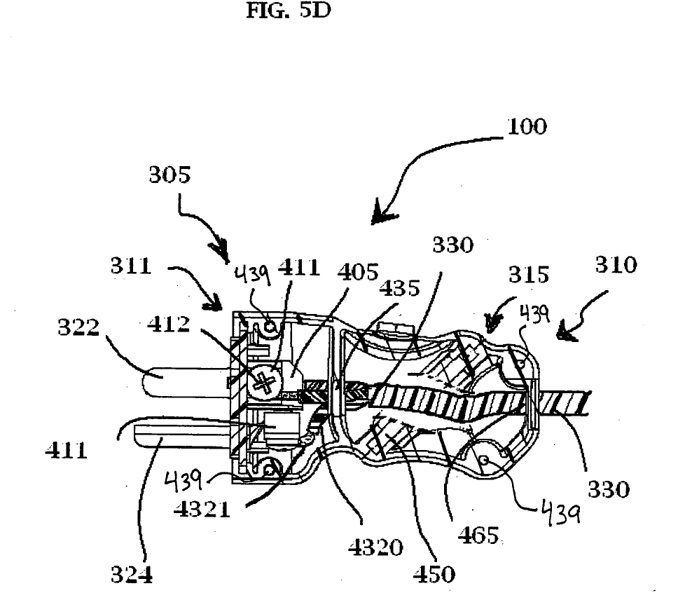

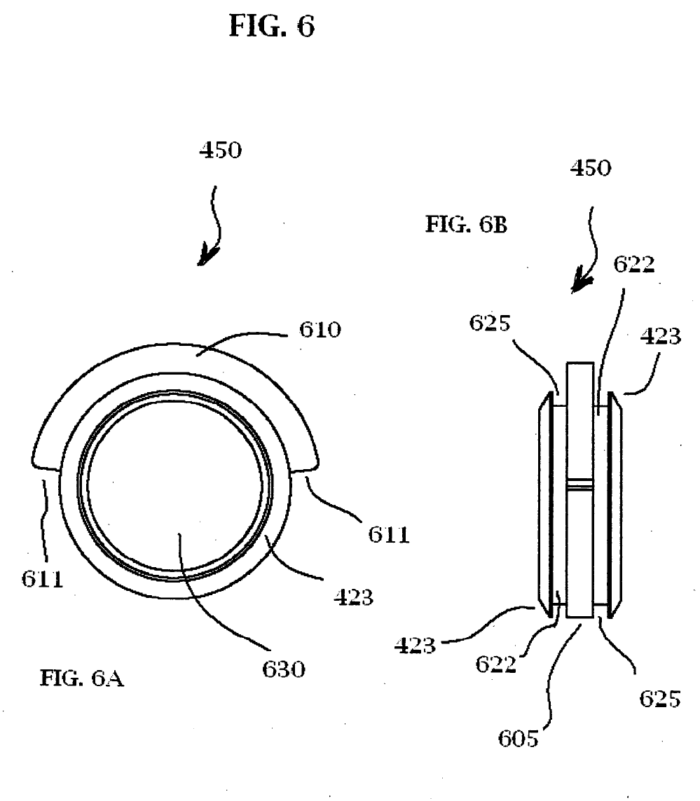

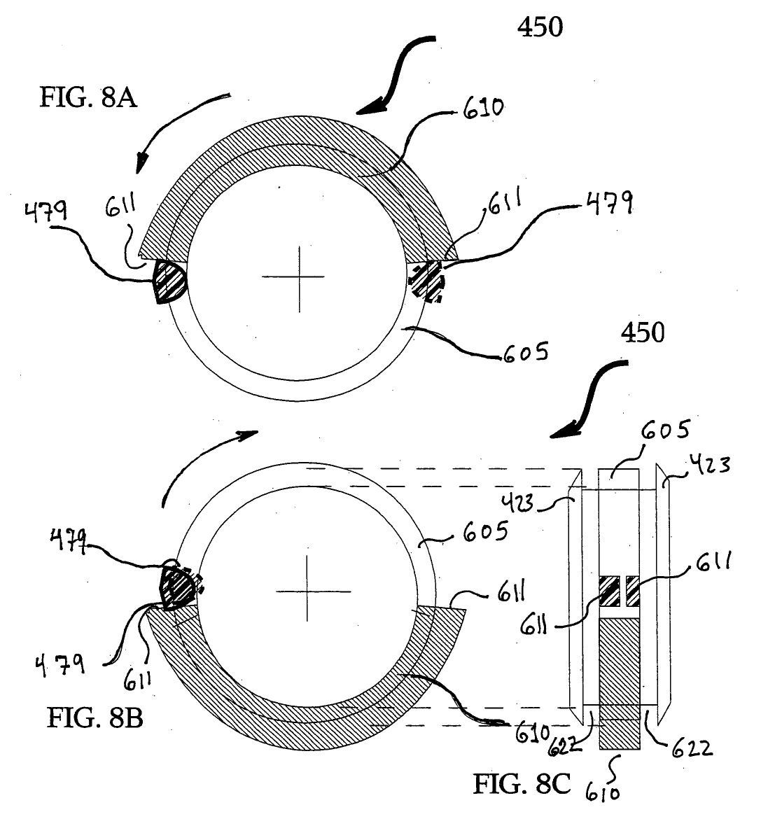

Rotary coupling 315 is formed by a rotating wiper 450 assembly that engages the mating circular grooves formed by the edge profiles of the mated half shells that form the rear and front halves of the rotating connector 100. The front and rear halves of the shell rotate with each other via the frictional engagement of the intermediate rotating wiper 450. Wiper 450 is in the general form of a ring with bore 630 for passing wires/cabling between the front and back halves of the connector 100. Wiper 450 is illustrated in more detail in FIG. 6, and can be considered to be assembled from a central wheel 605 surrounded on each side by axially centered spacer wheels 622, followed by blade wheels 423. The blade wheels 423 and central wheel 605 have a larger diameter than each spacer wheel 622 to define a circular recess 625 between the blade wheel 423 and the central wheel 605. The recess 625 fits into the circular frame edge of the front and back halves, as shown in FIG. 5D. A wedges portion 610 subtends a substantially hemispherical arc of the central wheel 605 as it extends outward past the diameter of the blade wheels 423. As shown in FIG. 4, the hemispherical track on the forward edge of shell 470, which forms the back half 310 of the connector, has a protruding stop 479 disposed midway between the two edges. The corresponding mating surface on the back edge of shell 440, which forms the front half 305 of the connector, has a protruding stop 479′ disposed midway between the two edges. The rotation of the wiper in the assembled connector is limited by the edges 611 and 611′ of wedge 610 abutting the protruding stops such that the rotary motion of the each half of the connector with respect to the other half is less than about 180 degrees in each direction with respect to the straight orientation shown in FIG. 3. The orientation of the wedge with respect to the respective ends stops in the front half 305 and rear half 310 of the connector is illustrated in FIG. 8 as an elevation of the wiper. Stops 479′ is associated with the front half 305 while stop 479 is associated with the back half 310. In FIG. 8A, the rear half 310 of the connector 100 has been rotated in the direction of the curved arrow, or counter clockwise, with respect to the front half 305. Edge 611 of wedge 610 is stopped by 479′ in the front half, further the front half cannot be rotated clockwise with respect to the rear half, as the opposite edge 611′ of wedge 610 is arrested by stop 479 (on the back half 310 of the connector and now 180 degrees opposite stop 479′ on the front half.) As the rear half of the connector is turned clockwise, as shown by the arrow in FIG. 8B, the wiper is likewise rotated clockwise, such that it's motion is arrested as stops 479 and 479′ are aligned with each other. Thus, in FIG. 8B, the angular displacement of stops 479 and 479′ has decreased from 180 degrees in FIG. 8A to 0 degrees with wedge end 611 and 611′ stopped by 479 and 479′ as shown in the edgewise elevation FIG. 8C.

In the preferred embodiment the rotating coupling 315 is limited to substantially 180 degrees rotation in a first direction and 180 degrees rotation in the opposing direction. Limiting the range of motion to less than 180 degrees in either direction prevents tangling or twisting of the wire strands of conductor cable 330.

In another aspect of a preferred embodiment, the right and left half of each housing shell, corresponding to the front or back halves of the connector, have one or more internal recesses for receiving assembly screws. The assembly screws are inserted through the outside of the other shell half via an external recess such that the head of the screw is below the flush shape of the connectors substantially circular wall. Thus, referring to FIG. 4, assembly screw 4411 is inserted into the recess 350 in front half shell 440 such that it engages the threads in bore 439 of the opposing front half shell 430. Back half 310 is assembled from half shells 460 and 470 which respectfully contain opposing internal and external recesses for receiving assembly screw 4711. Alternatively, the thread bore 439 molded into left half shell of the connector housings can be a convention nut inserted into a molded-in nut receiving recess on the outside of the connector.

In another preferred embodiment, the right or left half of each housing shell, corresponding to the front or back of the connector, has one or more prongs that function as a detent by mating with a corresponding slot in the opposite member to secure their attachment upon or during assembled of connector 100. Thus, in the most preferred embodiment, as shown in FIG. 4, the front half shells are mated with both a pronged detent 355, which attaches to recess 455 in half shell 440, as well as via assembly screws 4411. Additionally to aid in the alignment of prong 355 in recess 455, a prong guiding arm 446 extends outward from shell half 440, which on engaging a mating shelf on opposing half shell 426, guides the two half shells together such that detent prong is deflected downward and urged into recess 445. This configuration provides the advantages that the intermediate assembly is initially snapped together to avoid the need to apply inward pressure to each component while inserting assembly screws 4411.

Thus, during assembly the cord jacket of cable 330 is first stripped to expose insulated conductor wires 4320. Thereafter the conductor wire insulation is stripped to expose the bare conductor 4321. The bare conductor ends of cable 330 are then inserted through the bore 630 in wiper 450. Each bare conductor is then attached to the respective conductor blocks 411, on either plug assembly 410 or socket assembly 440. The plug or socket face assembly is then rotated as desired about the Z-axis before insertion into either of half shells 430 or 440. Accordingly, the conductor prongs or conductor terminal are thus oriented in the proper direction with respect the slanted back end of the front half 305 of the connector 100, as this determines the relative range of motion of the back half 310 with respect to the wall socket or electronic device as the connector half is rotated between 0 and 90 degrees in either the clockwise or counter clockwise direction. Thereafter, wire capture shims 438 may be placed as required around the collection of individual wires to the extent that the ordinary diameter of wire strain relief aperture 435 is too large to grip the assembly and provide strain relief. Likewise, cable capture shims 469 are optionally placed around the portion of cable 330 at exit or cable strain relief aperture 465, to the extent that the ordinary diameter of this opening at the end of the back half of the connector is too large to grip cable 330 to provide strain relief. Next, wiper 450 is inserted into the rear receiving recess of either of the shells 430 or 440 that form the connector's front half Thereafter, shells 430 and 440 are brought together fully surrounding both the face assembly and the wiper 450. Then, the back half shells 460 and 470 are inserted around and engaging wiper 450, as each half shell 460 and 470 that form back connector half 310 has a front recess profile that mates and engages the blade 423, recess 625 and wedge 610 of wiper 450. Next, assembly screws 4711 are inserted into the surface recess of back right half 470 for threading into the mating holes 439 in the back left half shell 460. The assembly screws can be inserted and threaded into the front half shell portions either before or after the back half of the rotating connector is assembled.

In a further and preferred embodiment of the invention, each half of rotating connector 110 preferably has an ergonomic grip shape to facilitate the grasping and rotation of the back half 310 with respect to front half 305. For example, as shown in FIG. 3, the front and rear halves of the rotating connector has an ergonomic grip shapes arising from a first concave depression 360 in the bottom of the front half 305 and a second concave depression 370 in the bottom of back half 310. More preferably the front half 305 and/or back half 310 are textured, for example by a series of closely spaced shallow grooves and/or ridges 380 on the outer surface.

In another embodiment of the invention, the shells 430 and 440 that form the front half 305 of connector 100 also include a label retaining recess 4404 which is eventually covered by windows 4410. Windows 4410 are formed of an arcuate bar of molded transparent resin having prongs 4312 that extend substantially vertical from each end. Thus, after a printed label sheet is inserted into recess 4404, the window 4410 readily “snaps” in place as the prongs 4312 are deflected inward toward the center of the window, to grasp the edge of the recess upon complete insertion. A perpendicular channel 4406 adjacent to the label retaining recess 4405, and permits window 4410 to be removed by a prying tool inserted therein.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A rotatable electrical connector comprising:
a) a substantially hollow front housing having a forward face and provided with a through hole defined in a rear face disposed at an oblique angle with respect to the forward face and a longitudinal axis of said front housing, the front housing including at least two elongated terminals disposed perpendicular to the forward face,
b) a substantially hollow back housing having a forward face and an exit face provided with a hole extending there between,
c) wherein the forward face of said back hollow housing rotatably engages the rear face of said front hollow housing such that the adjacent holes in said front and rear housings coincide during the rotation of the back housing about the longitudinal axis perpendicular to the rear face of said first hollow housing
d) wherein said front and rear housing engage via rotary coupling that includes an intermediate wiper disk.

2. A rotatable electrical connector according to claim 1 that further comprises a multi-conductor cable emerging from the exit face of said back housing wherein the individual conductors of said cable are connected to the terminals of said front housing.

3. A rotatable electrical connector according to claim 1 wherein the rotation of the front housing with respect to the back housing is limited to less than about 360 degrees.

4. (canceled)

5. A rotatable electrical connector according to claim 1 wherein the rotation of the wiper disk is retarded by stops in the front or back housing so as to limit the rotation of the front housing with respect to the back housing to less than about 360 degrees.

6. A rotatable electrical connector according to claim 1 that further comprises a label containing recess molded into the surface of at least one of said front and back housing.

7. A rotatable electrical connector according to claim 1 wherein at least one of said front and back housing is assembled from two symmetrical half shell portions.

8. A rotatable electrical connector according to claim 7 wherein the two symmetrical half shell portions are secured together by at least one of screws or a denting prong in assembling the front housing.

9. A rotatable electrical connector according to claim 1 wherein the terminals are selected from the group consisting of plug and socket connections.

10. A rotatable electrical connector according to claim 1 wherein at least one of said front and back housing has a textured or concave indented surface portion to improve the gripping thereof.

11. A rotatable electrical connector according to claim 1 that further comprises means to modify the orientation of face assembly terminals by rotation about the longitudinal axis of the forward housing.

12. A rotatable electrical connector according to claim 11 wherein said means to modify the orientation of face assembly terminals comprises providing a polygonal edge to a face assembly that contains the two or more terminals and engages a complimentary polygonal recess formed in the internal periphery of a front opening in the hollow front housing.

13. A rotatable electrical connector comprising:
a) a substantially hollow front housing having a forward face and provided with a through hole defined in a rear face disposed at an angle of about 45 degrees with respect to the forward face, including at least two elongated terminals disposed perpendicular to the forward face,
b) a substantially hollow back housing having a forward face and an exit face provided with a hole extending there between,
c) wherein the forward face of said back hollow housing rotatably engages the rear face of said front hollow housing such that the holes in said front and rear housings coincide during the rotation about a common axis perpendicular to the rear face of said front housing
d) wherein said front and rear housing engage via rotary coupling that includes an intermediate wiper disk.

14. A rotatable electrical connector according to claim 13 that further comprises a multi-conductor cable emerging from the exit face of said back housing wherein the individual conductors of said cable are connected to the terminal of said front housing.

15. A rotatable electrical connector according to claim 13 wherein the rotation of the back housing with respect to the front housing is limited to less than about 360 degrees.

16. (canceled)

17. A rotatable electrical connector according to claim 13 wherein the rotation of the wiper disk is retarded by stops in the front or back housing so as to limit the rotation of the back housing with respect to the front housing to less than about 360 degrees.

18. A rotatable electrical connector according to claim 14 wherein the rotation of the back housing with respect to the front housing is limited to less than about 360 degrees.

19. (canceled)

20. (canceled)

21. A rotatable electrical connector according to claim 2 wherein the rotation of the front housing with respect to the back housing is limited to less than about 360 degrees.

22. A rotatable electrical connector according to claim 2 wherein at least one of said front and back housing is assembled from two symmetrical half shell portions.

23. A rotatable electrical connector according to claim 2 wherein the two symmetrical half shell portions are secured together by at least one of screws or a denting prong in assembling the front housing.

24. A rotatable electrical connector according to claim 14 wherein the rotation of the back housing with respect to the front housing is limited to less than about 360 degrees.
